(19) United States
(12) Patent Application Publication
(10) Pub. No.: US 2020/0357046 A1
(43) Pub. Date: Nov. 12, 2020

(54) PORTABLE HAND HELD BATTERY POWERED PERCUSSIVE MASSAGER RENTAL SYSTEM

(71) Applicant: Tristan William McGann, Santa Monica, CA (US)

(72) Inventor: Tristan William McGann, Santa Monica, CA (US)

(21) Appl. No.: 16/868,963

(22) Filed: May 7, 2020

Related U.S. Application Data
(60) Provisional application No. 62/845,213, filed on May 8, 2019.

(51) Int. Cl. G06Q 30/06; G06Q 20/12; G06Q 20/02; G06Q 20/32; H04W 4/20

(52) U.S. Cl. CPC G06Q 30/0645; G06Q 20/127; G06K 19/06037; G06Q 20/3276; H04W 4/20; G06Q 20/027

(57) ABSTRACT

Portable hand-held battery powered massagers and systems that allows for automated rental of the massager are disclosed. The system allow for the massagers to be freely rented anywhere within a vicinity without physical security and includes mobile devices and remote computing operating systems that communicate with each other and the massager. Activation of the massager is initiated automatically upon rental via independent control over the transmission of the power source to the electric motor that drives the massager tip. Built in GPS tracks, locates, and deters theft of massagers. Expiration of the rental time deactivates the massager and renders it inoperable.

### INCORPORATION BY REFERENCE TO RELATED APPLICATIONS

The present application claims benefit of and priority to U.S. Provisional Patent Application No. 62/845,213, filed May 8, 2019, which is hereby incorporated herein by reference in its entirety.

### TECHNICAL FIELD

The field of the invention relates to massage devices and controlled access and use thereof and more particularly to portable hand-held battery powered massagers with built-in rental capability and systems, methods, and stations therefore.

### BACKGROUND

Physical exercise and well-being has long been understood as imperative to a healthy life-style and longevity. As society has increasingly moved toward sedentary “desk” jobs, many people have increasingly turned to exercise facilities such as clubs, gyms, and/or community centers. Massage therapy can be a vital component of enhancing and sustaining an active life style whether at work or play. While some have means to hire or otherwise engage professional massage therapist to relieve pain, sore muscles, improve range-of-motion, posture, and recovery time, many lack those resources or don't have the time to plan and schedule professional massage therapy—the need for which may arise unexpectedly. In attempt to bridge this gap, various massage devices and apparatuses have been developed, including various passive devices such as rollers and balls and various active devices such as massage-chairs and percussive massage devices. Quality active percussive massage devices, however, are often quite expensive and unaffordable, non-portable, and can require regular maintenance.

The inventor here recognized that there is a continued need to increase access to quality active massage therapy equipment that is portable, affordable and convenient accessible.

### SUMMARY

Consistent with the foregoing, described herein are portable hand-held battery powered massagers and methods of use, rental systems and stations therefore, which may be employed by gyms, sports and health clubs, fitness studios, offices, hotels, and other facilities such as apartments, condos, community club houses, that provide exercise or fitness facilities to its members, customers or employees. Various aspects are summarized herein.

Particular aspects relate to a portable hand-held battery powered massager and system that allows for automated rental of the portable hand-held battery powered massager. In a particular implementation, a “scan-to-rent” system is disclosed. Rental and return of the portable hand-held battery powered massager may be facilitated via scanning a machine readable identification or code (e.g., QR code, NFC tag) associated with the portable hand-held battery powered massager using interactive rental software such as a mobile application residing on the user's smart phone or other computing device and/or via a web based application. Alternatively or in addition to scanning, a device code can be manually entered into the rental software interface by the user via keying in an identifier or code associated with the portable hand-held battery powered massager device or otherwise provided by the user.

In some aspects, the rental software facilitates communication with the portable hand-held battery powered massager and is capable of facilitating selection of a rental duration or starting a metered rental timer, connecting to a payment gateway, and upon payment confirmation, activating the portable hand-held battery powered massager for use.

In some embodiments, the user may be billed for rental usage of the massage device through the club, gym or other facility regular membership invoice, such as monthly or quarterly etc. In some embodiments, the user can be charged in accordance with the rental session or duration time, by the metered time used, or through a pre-paid amount of time or monthly subscription associated with the user.

Activation, may include a micro controller or circuit that controls the rechargeable battery in the device. In yet other aspects, the rental software may include mapping/GPS capability to allow the user to locate available portable hand-held battery powered massager for rent or determine the charge remaining on such devices.

Communication with the portable hand-held battery powered massager may be wireless via for example Bluetooth (BLE) or some other suitable wireless communication protocol and/or via a cabled connection (e.g., USB or other suitable connection). A wireless communication circuit, such as a BLE module, may thus be included in the portable hand-held battery powered massager and may be connected to a power control circuit, such as a micro controller, that turns on or otherwise allows the rechargeable battery power source to power the device

The portable hand-held battery powered massager may be suitably adapted so that it may be left unattended and physically unrestrained at a charging station (such as a self-service kiosk), physically tethered or otherwise restrained to a particular charging station, or left anywhere (e.g., in a gym or workout facility, an office building, co-working spaces like those marketed by WeWork™, retirement home etc.) after use and rental. Thus, for example, the user may obtain possession of the portable hand-held battery powered massager at a first location in a facility use it and leave it at a second location in a facility. By way of another example, the user may obtain possession of the portable hand-held battery powered massager at a first facility or location, use it at home, and drop it off at a second facility or location different than the first.

To facilitate greater access, portability and use, the portable hand-held battery powered massager may include a rechargeable battery with extended battery life (e.g., 4 hours). Once the battery is depleted, the portable hand-held battery powered massager can be recharged at a designated facility that is specifically adapted for recharging the device. Alternatively, the device may be adapted to allow for recharging via common charging interfaces or plugs, which would allow the user to charge the device at any suitable location (e.g., at home, in the car, work etc.). The power of the massager may be charged wirelessly or cordlessly through, for example, inductive charging by known standard, for example, Qi or PMA.

In one implementation, activation of the portable hand-held battery powered massager automatically activates a timer in the mobile app, web software, and/or micro controller for the duration of time selected or the rental period. The user may be charged on a per minute or set-time basis for the duration of time the device is used and/or activated. The user may be charged on a membership model or subscription basis that the charge is based on membership fees or subscription fees. The duration of time the device is used and/or activated is unlimited for membership or subscription models. The duration of time the device is used and/or activated is limited to a certain amount of time allotted to use for a certain amount per month for membership or subscription models.

When the rental period expires, the portable hand-held battery powered massager may automatically power OFF. The user may also terminate the rental period via a stop rental button on the mobile or web application or potentially by turning-off the portable hand-held battery powered massager through an user interface on the device. A GPS module may be integrated within the portable hand-held battery powered massager to facilitate location of the device and deter theft. Alternatively, GPS can be replaced with or supplemented by a Bluetooth 4.0 long range tracker circuit.

In yet another aspect, users may buy or own one or multiple massage devices and add them (e.g., through a registration process) to an operator network that employees a massager rental system described herein. People that live/work locally to the user/owner (e.g., in the same apartment building or same office building) could rent them and the user/owner would automatically receive passive income derived from the rental of their massage device(s). A special access or activation code/password may be provided to a user/owner so they wouldn't have to pay when they used a massage device owned by them. User/owners would thus leverage the operator network to their benefit, while the operator network would benefit by reducing the capital costs associated with the investment required to own and/or maintain the massage device equipment.

Additional details regarding the various aspects of the subject matter described herein are set forth in the accompanying drawings and descriptions below and/or are otherwise apparent therefrom. It should be understood that the descriptions and illustrations herein, while illustrative of the various aspects of the disclosed subject matter, it is the claims that are intended to define the appropriate scope of the protected subject matter.

### BRIEF DESCRIPTION OF THE DRAWINGS

The accompanying drawings, which are incorporated in and constitute a part of this specification illustrate certain aspects of the subject matter disclosed herein and together with the description, help explain aspects associated with the disclosed implementations.

FIG. 1 illustrates an exemplary portable hand-held battery powered massager in accordance with the disclosed subject matter.

FIGS. 2A-2B illustrate user interface screen depictions for a rental software application that facilitates interaction and communication with the portable hand-held battery powered massager of FIG. 1. The screen depictions are rendered in the context of a smart phone, however, it should be understood that the application could be used by other computing and mobile computing devices such as tablet or laptop computers and desk top computers.

FIG. 3 is a system diagram illustrating a rental system comprising the exemplary portable hand-held battery powered massager illustrated in FIG. 1 and the rental software application illustrated in FIGS. 2A-2B.

FIG. 4 is a flow-chart setting forth steps performed in connection with rental and use of the portable hand-held battery powered massager illustrated in FIG. 1 with the rental software application illustrated in FIGS. 2A-2B in accordance with the system illustrated in FIG. 3.

### DETAILED DESCRIPTION

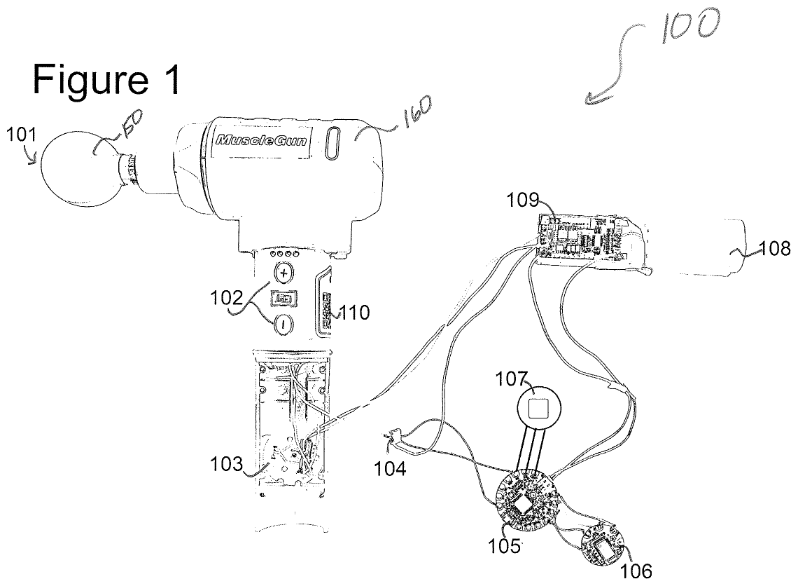

FIG. 1 is an exploded view diagram of a portable hand-held battery powered massager 100 with built-in electronic control rental interface in accordance with the disclosed subject matter. The portable hand-held battery powered massager 100 comprises a massage tip 150, a housing 160, a rechargeable battery 108 that is coupled and powers an electric motor contained within the housing to drive the movement of the massage tip 150, an externally accessible user interface 102 capable of activating and adjusting the power to the electric motor and hence the speed of the electric motor and corresponding movement of the massage tip 150. In the illustrated implementation, user interface 102 is comprised of a manual speed controller ranging from 0-9. When the controller is set to 0, the massager is idle but power is still ON (to the extent that the massager 100 is activated as described below) and the user may still be charged a rental charge depending on the rental charge scheme as described below. The 0 speed position allows the user to set the device down or change the massage tip 150. Thus, it should be understood that a massage tip 150 may come in any suitable form or shape and may be replaceable and/or built in. Thus, in one implementation, the massage tip 150 is adapted to be replaced or swapped-out with other massage tip form factors that are designed for particular muscle groups or particular uses.

Operability of the user interface 102 can be controlled by a MOSFET solid state relay 104, which is in turn controlled by micro-controller 105. The micro-controller 105 can be electrically connected to the MOSFET solid state relay 104, a BLE wireless communication module 106, a GPS module 107, and a battery charger control board 109 that controls the transmission of power to and from the rechargeable battery 108. Each of the foregoing components can be housed within the housing 160 and powered by the rechargeable battery 108.

Also included within the housing 160 is a DC charge input circuit board 103 that is adapted to receive power from an external power source to facilitate charging of the portable hand-held battery powered massager 100 before and after use. The DC charge input circuit board 103 is connected to the rechargeable battery 108 via the battery charger control board 109 and is connected to a charging interface (e.g., a USB or other suitable conventional or proprietary connector) that is adapted to connect to an external power source (AC or DC) to charge the rechargeable battery 108.

The MOSFET solid state relay 104 can be directly connected to the output of the battery 108 and controlled by the microcontroller 105, which can also be powered by the battery 108. When the controller 105 sends an activation signal to the MOSFET solid state relay 104 and the user turns the user interface 102 to the ON position, power from the battery 108 is capable of being transmitted to the electric motor. Thus, the MOSFET solid state relay 104 and the user interface 102 each constitute separate independent controls that regulate whether the electric motor receives power from the battery 108. The MOSFET solid state relay 104, however, can be controlled through the rental software application as described in more detail below. The MOSFET solid state relay 104 may include one or more externally visible indicators (e.g., LED lights) that correspond to the ON and/or OFF state of the MOSFET solid state relay 104 and hence whether the portable hand-held battery powered massager 100 is in an operable state, such that if the user turns the user interface 102 to the ON position, the electric motor will be powered and drive the massage tip 150.

In one implementation, the rechargeable battery 108 may be comprised of multiple lithium ion battery cells. For example, rechargeable battery 108 may be comprised of six (6) 3.7 volt lithium ion battery cells totaling 22.2 volt. Such a battery bank has been found to allow for up to four (4) hours of use. Increased battery life may extend the rental shelf-life of the portable hand-held battery powered massager 100.

The GPS circuit 107 facilitates tracking of the massager 100. Location tracking of the device facilitates both location by users interested in renting the device as described in greater detail below as well as operators interested in deterring theft of the device 100. The GPS circuit 107 may have a stand-alone wireless communication circuit and/or may communicate wirelessly through the BLE wireless communication circuit 106. A GPS circuit 107 may be replaced with or supplemented by a Bluetooth 4.0 long range tracker circuit, which in turn is connected with another computing device that tracks the massager and/or triggers an alarm and/or disables the massager if the massager 100 is moved beyond a set perimeter so as to effectuate a geo-fence that is capable of automated policing.

The BLE wireless communication module 106 is adapted to receive and/or transmit wireless communication from and/or to a corresponding BLE equipped device or interface such as a smart phone 302 or other mobile or computing device. The microcontroller 105 processes incoming signals from the BLE module 106 to control the operation of the solid state relay 104 and hence thereby control activation of the portable hand-held battery powered massager 100 and whether it is capable of being operated by the user.

The microcontroller 105 may also be adapted to keep track of operation or rental time and communicate that information via the BLE module 106 to the smart phone 302 or other device so that the information can be used in calculating rental payment. Upon expiration of the rental time or termination of the rental, the microcontroller 105 sends a signal to the MOSFET solid state relay 104 thereby electronically switching the internal power circuit to the off position and rendering the portable hand-held battery powered massager 100 in operable.

The device may also include an identification code 110, such as a QR code or some other identification code associated with the device, that can be scanned or inputted by the user into a rental software application to facilitate rental and activation of the device 100.

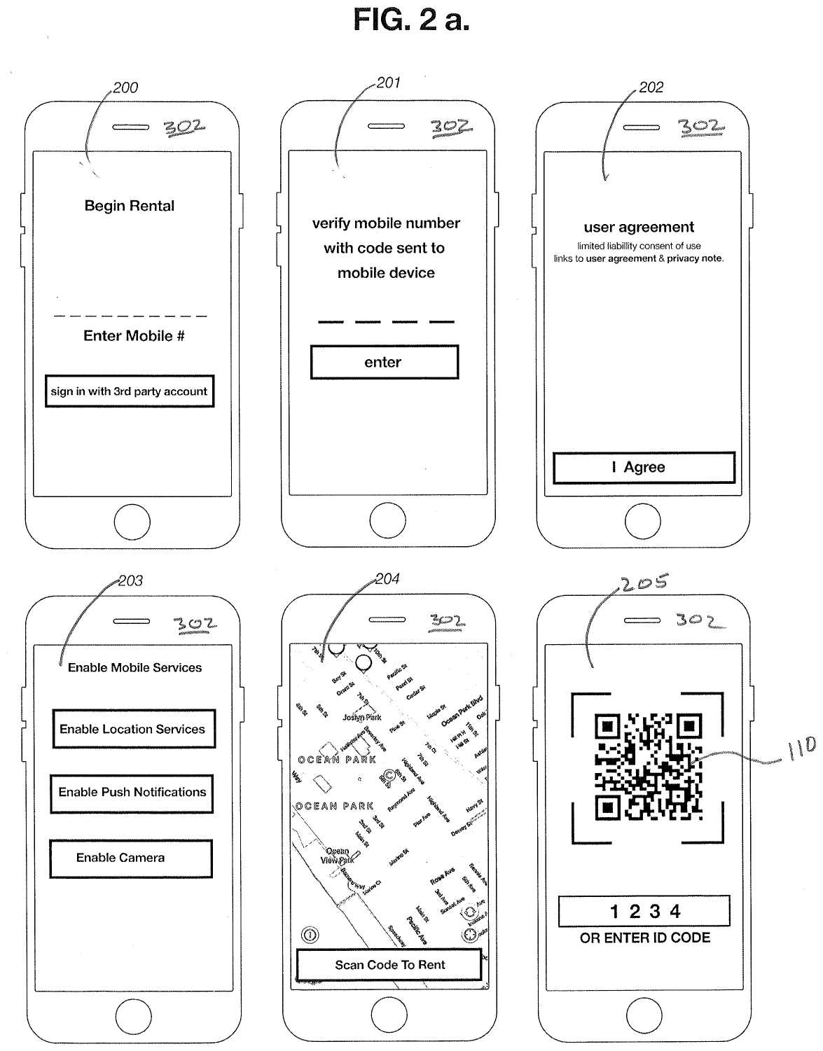

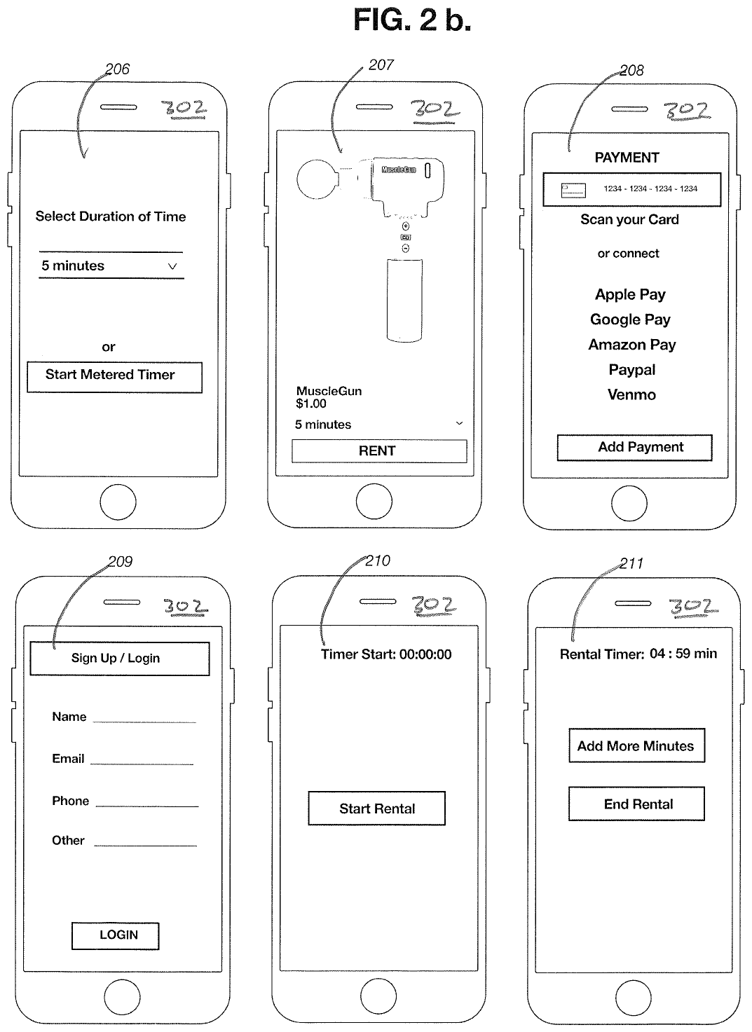

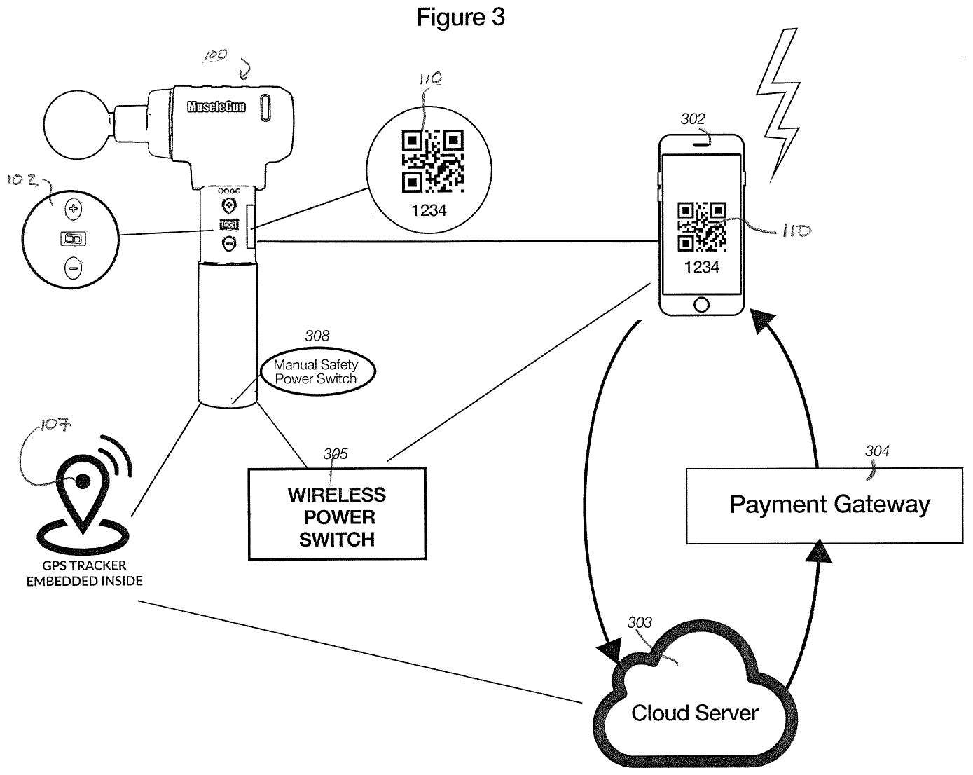

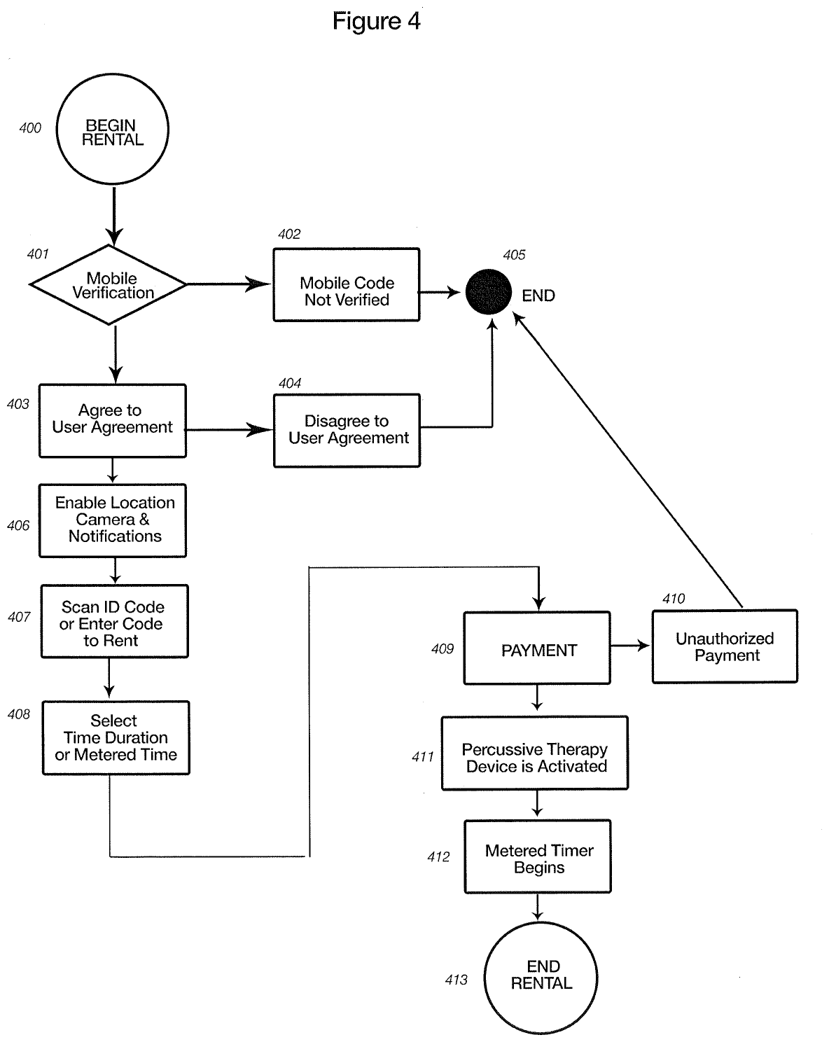

The portable hand-held battery powered massager rental system disclosed herein is now further described with reference to the rental system diagram illustrated in FIG. 3, the user interface screen depictions of the rental software illustrated in FIGS. 2a-2b, and the steps described in FIG. 4. As illustrated in FIG. 3, it should be understood that communication between a user's smart phone 302, the remote computing system 303 (e.g., the cloud based server), and the portable hand-held battery powered massager 100, may be accomplished through any suitable wireless or wired communication. Thus, for example communication between (a) a user's smart phone 302 and the portable hand-held battery powered massager 100 (b) a user's smart phone 302 and the remote computing system 303, and (c) the remote computing system 303 and the portable hand-held battery powered massager 100, may be through Bluetooth communication protocols effectuated by the BLE circuits on each device and/or some other wireless communication protocol (e.g., mobile, wireless network, infrared, satellite) effectuated by corresponding hardware on those devices.

As illustrated in FIGS. 2a and 4, after the user downloads the software on to the user's smart phone 302, the rental process begins (step 400, FIG. 4) with the user opening the rental software application on the user's smart phone 302. After the user opens the rental software application, a mobile verification process (step 401, FIG. 4) is initiated. The user is presented with a Begin Rental user interface screen (200, FIG. 2), which queries the user to enter the mobile telephone number associated with the user's smart phone 302. Upon entering the mobile number, the rental software application communicates the mobile telephone number (e.g., via the wireless communication hardware of the smart phone device 302) to a remote computing system (303, FIG. 3) that receives the mobile telephone number and generates a verification code that is communicated back to the user's smart phone 302 via any suitable means such as via text massage, email, voice massage, etc.

The rental software application then presents the user with a Verification Code user interface screen (201, FIG. 2a) that queries the user to enter the verification code that was sent to the user's smart phone 302. Upon receipt of the verification code, the user enters the verification code as requested by the Verification Code user interface screen 201. In response, the rental software application communicates the verification code to the remote computing system (303, FIG. 3), which receives the verification code and determines whether the verification code is valid (i.e., corresponds to the verification code previously sent to the smart phone 302). If valid, the remote computing system 303 instructs the rental software application to proceed with the rental process. If the verification code is invalid (or otherwise not validated by the remote computing system 303), the remote computing system 303 communicates the lack of validation with the smart phone 302 and the rental software application. Failure to receive a verification code validation (step 402, FIG. 4) from the remote computing system 303 results in the rental software application either presenting another user interface screen requesting the user to reenter a correct verification code or terminating the rental process (step 405, FIG. 4) thereby requiring the user to begin the rental process over again or enter another mobile telephone number to restart verification process (step 401, FIG. 4).

Once verification process is successfully completed, the rental software application may then present the user with a User Agreement interface screen (202, FIG. 2a) that provides the rental agreement terms including privacy policy and requests the user to agree to those terms. If the user agrees to the rental agreement (step 403, FIG. 4) then the rental process continues to step 406, wherein the rental software application presents the user with an Enable Mobile Services user interface screen (203, FIG. 2a), which the user can affirmatively enable (step 406, FIG. 4) so that location services, push notifications and camera features of the smart phone 302 are allowed to operate with the rental software application. Enabling these features will facilitate an easier more friendly rental process. If the user fails to agree to the rental agreement terms (step 404, FIG. 4), the rental software application either presents another user interface screen requesting the user to agree to the rental agreement terms or terminates the rental process (step 405, FIG. 4) thereby requiring the user to begin the rental process over again as previously described. Alternatively the rental software application may proceed without those features enabled, in which case aspects of the rental process that require those features would not be employed.

The user is then presented with a Location Map user interface screen 204 (FIG. 2a) which presents to the user locations where portable hand-held battery powered massagers 100 are available for rent so that the user can obtain possession and rent the device. The Location Map user interface screen 204 may further include an interactive button (represented as a “Scan Code To Rent” that will initiate a user interface screen 205 (FIG. 2a) that will allow the user to input an identification code 110 (FIG. 1) associated with a particular portable hand-held battery powered massager 100 that the user is interested in renting. Map user interface screen 204 may also be the initial or primary screen presented by the rental software application to the user in subsequent rentals. Hence, it should be understood that steps 401, 403, 406 and corresponding user interface screens 200, 201, 202, and 203 may be part of the initial rental software application download and set-up process and may be skipped-over after that initial download and set-up process is completed, such that the user need not be required to move through those steps/screens for subsequent rentals.

In accordance with rental process step 407 (FIG. 4) and as illustrated in user interface screen 205, the rental software application presents the user with a portable hand-held battery powered massager 100 device identification code input interface that allows the user to rent a particular massager 100. To the extent that the camera feature is enabled as previously described above, the user interface screen 205 allows the user to use the smart phone 302 camera to capture or scan the QR code (or other machine readable code) associated with the massager 100. To the extent that the camera features is not enabled, the user interface screen 205 is adapted to allow the user to manually enter an identification code for the massager 100. In the embodiment illustrated in FIG. 1, the identification code (e.g., the QR) is physically affixed and visible on the externally on the massager. Alternatively the identification code may be embedded in an RFID (Radio-Frequency Identification) or NFC (Near-Field Communication) tag or other memory chip positioned within the security of the housing 160, thereby protecting the identification code from being removed, exchanged or otherwise tampered with.

In accordance with rental process step 408 (FIG. 4) and as illustrated in user interface screen 206, the rental software application presents the user with rental options, such as rental based on a set duration of time (e.g., 5 minutes for a $1) or rental based on metered time (e.g., 20 cents per minute). Once the user selects the rental time option, the user is presented with a confirmation rental screen 207 that confirms the rental time option selected and provides the user with a rent button or interface to confirm the rental in accordance with the rental time option selected.

Upon the user confirming rental, in accordance with rental step 409 (FIG. 4) and as illustrated in the Payment user interface screen 208, the rental software application presents the user with rental payment options, such as through the scanning or input of a physical credit card, a gym account number and pin, or through a mobile payment or digital wallet services such as Apple Pay, Google Pay, Amazon Pay, PayPal, Venmo etc. Once the user selects the payment option, the rental software application either validates the payment option and/or connects the user with a corresponding payment gateway such as Stripe, Braintree, PayPal, Appleypay, Amazonpay, square, Venmo or other secure payment gateway processor (as illustrated in the system diagram of FIG. 3), which allows the user to enter their payment details to facilitate the rental payment through the user selected payment service. If the payment option selected is not authorized (step 410, FIG. 4) by the payment gateway, the rental software application advises the user that the payment option was not authorized and either presents another user interface screen requesting the user to select a payment option (208, FIG. 2; step 409, FIG. 4) thereby requiring the user to begin the payment process over again as previously described. Alternatively the rental software application may terminate the rental process (step 405, FIG. 4).

While representative payment options are described, it should be understood that payment could be free/sponsored by a company or included in club, gym or other facility membership cost and/or linked to a club, gym or other facility membership card on file with the rental operator (e.g., in a database in the remote computing system 303, FIG. 3). The user may be billed for rental usage of the massage device through the club, gym or other facility regular membership invoice, such as monthly or quarterly etc. In which the remote computing system 303 may directly communicate with such facility or membership to provide invoicing or facilitate payment for the rental by or through the facility or membership, which in turn invoices the user in accordance with the facility or membership agreement with the user.

The rental software application may also present a User Login interface screen 209 that is adapted to obtain user information such as name, email, phone number, and other information such as Gym membership or other account number associated with the user. The user login information may be communicated to the remote computing system 303 and stored in a databased therein for future reference or look-up. The user login information may be used to facilitate future logins, which can streamline the payment process by relying on prior payment option preferences or selections. Thus, when the user later login, the rental software application may presumptively proceed using the prior payment option selected by the user.

Once the payment option is authorized, the massager 100 is activated (step 411, FIG. 4). In the illustrated implementation, activation is facilitated through Bluetooth communication between the smart phone 302 BLE circuit and the BLE circuit 106 in the massager 100, which sends an activation command to the microcontroller 105, which in turn switches the relay 104 into the ON or operable position. The remote computing system 303 and/or payment gateway may communicate payment authorization to the smart phone 302, which in response sends an activation command to the massager 100. As previously described, the activation state of the massager 100 may be indicated visually by lights (LEDs) or other means externally on the massager 100. The rental software application presents a Rental Time user interface screen 210 with a timer and a start rental button. As per step 412 (FIG. 4), activation of the massager may automatically trigger the start of the rental timer. Alternatively the rental timer may be triggered to start when the user touches the start rental button on user interface screen 210.

After rental time begins, the rental software application presents a Rental Status and Termination user interface screen 211 to the user that provides the rental time and provides the user with interactive buttons that provide the user an interface by which to add additional time and/or end the rental. The rental time will run for the pre-selected duration or continue to run until the user selects the end rental button depending on the rental time option selected by the user as previously described in connection with screen 206. Once the duration of time has ended or the user selects the end rental button, the rental will end (step 413, FIG. 4) and the massager 100 will return to the inactive state by the microcontroller 105 sending a signal to the relay 104 that switches the relay into the OFF or inoperable position thereby disconnecting the rechargeable battery 108 from the electrical motor. The microcontroller 105 may have an internal clock or timer that corresponds with and is set by the duration of time selected by the user in screen 206, which in response to expiration thereof is programmed or otherwise adapted to automatically switches the relay 104 to the OFF or inoperable position. Alternatively, the microcontroller 105 may be instructed to switch the relay 104 into the OFF position by the rental software application via Bluetooth communication from the smart phone 302, for example once the rental time period has ended or if a kill power command is sent from the smart phone 302 and/or remote computing system 303 thereby effectuating a wireless power switch (305, FIG. 3). In addition, it is contemplated that the user interface 102 of the massager 100 may include a manual ON/OFF switch 308 (FIG. 3) that can end the rental and/or deactivate the massager 100. The manual ON/OFF switch may operate by sending a command signal to the relay 104 directly or indirectly via the microcontroller 105 or alternatively may disconnect the battery 108 from the electric motor through a separate connection.

Once the rental is ended (step 413, FIG. 4), the user is charged in accordance with the rental session or duration time, by the metered time used, or through a pre-paid amount of time or monthly subscription associated with the user.

Unrented massagers 100 may be stored in charging stations or kiosks located at one or more facilities that are capable of communicating with the remote computing system 303. Operators of the rental system may interface with the remote computing system 303 to determine the location, maintenance needs (e.g., charging requirements), rental status of the massagers 100 and to administer user accounts, initiate updates of the rental software applications, and other administrative needs required to operate the rental system.

In one implementation, users may buy or own one or multiple massage devices and add them (e.g., through a registration process) to an operator network that employees a massager rental system described herein. People that live/work locally to the user/owner (e.g., in the same apartment building or same office building) could rent massager and the rental system would automatically initiate payment via the payment gateway 304 to the user user/owner of an agreed to royalty or payment amount from rental income derived from the rental of their massage device(s). The massage device registration process could be implemented via a user interface screen that is presented after the user agreement screen 202 that queries the user as to whether the user wishes to register a user/owned device to the operators rental network and if so provides the user interface screen like that depicted in user interface screen 205 wherein the user can scan or key-in identification code associated with the user-owned massage device. The rental system may then via the remote computer system provide a special access or activation code/password to a user/owner that results in the user/owner having a reduced-price or free use a massage device owned by the user/owner. The rental system, would thus allow user/owners to leverage the operator's rental system to generate a benefit via a return on user/owner's capital investment of the massager, while the operator would benefit by reducing the capital costs required to own and/or maintain the massage device equipment. The rental system via the remote computer system 303 may alert the user/owner with information regarding the maintenance and location of a massage device 100 owned by the user to facilitate the user's maintenance and charging of the massager 100. If the user/owner is no longer interested in participating in an rental operator's network (e.g., because the user moved or is no longer interested in renting his/her device), the user could remove the massager from an operators network via a reverse registration process and/or thereafter register the massage device in another operators network at a different location.

The rental software applications may provide the user guidance on how to use the massager device. For example, the rental software applications provide the user on massage techniques and tips, for example, via video tutorials or guided audio.

It should be understood that the foregoing devices, steps, user interface screens and process are representative and may be implemented in whole or part in different ways or in a different order. For example, the Enable Mobile Services user interface screen 203 (FIG. 2a) may be broken up into multiple user interface screens (e.g., one user interface screen for each of the three enable requests. By way of another example, the verification code generated by the remote computing system 303, may be sent to a user's social media account and retrieved by the user and entered into the smart phone 302 at screen 201 as opposed to being sent directly to the user's smart phone. Further, the rental software application (in whole or in part) may be hosted on a remote computing system (as opposed to the user's smart phone 302) that is accessible to the user via a user's smart phone 302 or other computing device. Thus, for example, the remote computing system could be a part of a charging station or a check-in/check-out kiosk. While reference is made to a smart phone 302 it should be understood that a smart phone 302 may be substituted for any mobile device such as computing tablet, laptop, or other computing device.

Thus, the foregoing disclosure describes by way of illustration and examples specific embodiments in which the subject matter may be implemented or practiced. It should be understood that other embodiments may be utilized and that structural and logical substitutions and changes may be made that fall within the scope of this disclosure, which is intended to cover any adaptations and variations of the various embodiments disclosed herein and combination of the various features and component elements thereof.

What is claimed is:

1. A portable hand-held battery powered percussive massager rental system comprising:
a portable hand-held battery powered percussive massager including a housing that houses a rechargeable battery, a motor, a first wireless communication circuit, and one or more controllers;
a mobile computing device comprising a rental application and a second wireless communication circuit, the rental application including an interactive user interface that accepts user inputs and process the user inputs to generate activation commands, the computing device wirelessly communicating the activation commands to the massager via the first and second wireless communication circuits; and
a remote operating computing system that wirelessly communicates with the mobile computing device,
wherein the activation commands are processed by the one or more controllers to connect and disconnect the rechargeable battery to facilitate use and termination of use of the massager in accordance with the activation commands,
wherein the remote operating computing system controls the rental application ability to activate the massager.

2. The system of claim 1, wherein the rental application provides massage techniques and tips via video tutorials.

3. The system of claim 1 further comprising a machine readable identification associated with the portable hand-held battery powered massager.

4. The system of claim 3, wherein the machine readable identification is a QR code.

5. The system of claim 1 further comprising a device code that is able to be manually entered into the user interface.

6. The system of claim 1, wherein one of the first and second wireless communication circuits is a BLE module.

7. The system of claim 1, wherein the rental application facilitates communication with the portable hand-held battery powered massager.

8. The system of claim 7, wherein the rental application facilitates a selection of a rental duration.

9. The system of claim 7, wherein the rental application facilitates starting of a metered rental timer.

10. The system of claim 7, wherein the rental application facilitates connecting to a payment gateway, and wherein upon payment confirmation activating the portable hand-held battery powered massager.

11. The system of claim 10, wherein the activating of the portable hand-held battery powered massager automatically activates a timer in the rental application and/or the one or more controllers for the duration of time selected or the rental period.

12. The system of claim 11, wherein the payment is charged based on the duration of time the massager is activated.

13. The system of claim 12, wherein when a rental period expires, the portable hand-held battery powered massager is automatically power off.

14. The system of claim 1 further comprising a Bluetooth 4.0 long range tracker circuit.

15. The system of claim 1, wherein the user obtains possession of the portable hand-held battery powered massager at a first location in a facility, then uses it and leaves it at a second location in the facility.

16. A method of providing a portable hand-held battery powered percussive massager rental system, the method comprising:
providing a portable hand-held battery powered percussive massager including a housing that houses a rechargeable battery, a motor, a first wireless communication circuit, and one or more controllers;
providing a mobile computing device comprising a rental application and a second wireless communication circuit, the rental application including an interactive user interface that accepts user inputs and process the user inputs to generate activation commands, the computing device wirelessly communicating the activation commands to the massager via the first and second wireless communication circuits;
providing a remote operating computing system that wirelessly communicates with the mobile computing device; and
processing, by the one or more controllers, the activation commands to connect and disconnect the rechargeable battery to facilitate use and termination of use of the massager in accordance with the activation commands, wherein the remote operating computing system controls the rental application ability to activate the massager.

17. The method of claim 16 further comprising:
providing a machine readable identification associated with the portable hand-held battery powered massager.

18. The method of claim 16 further comprising:
providing a device code that is able to be manually entered into the user interface.

19. The method of claim 16 further comprising:
facilitating, by the rental application, communication with the portable hand-held battery powered massager.

20. The method of claim 19 further comprising:
connecting to a payment gateway; and
activating the portable hand-held battery powered massager upon a payment confirmation.
